(19) United States
(12) Patent Application Publication
(10) Pub. No.: US 2003/0149621 A1
(43) Pub. Date: Aug. 7, 2003

(54) Alternative advertising

(75) Inventor: Yevgeniy Eugene Shteyn, Cupertino, CA (US)

Correspondence Address: Corporate Patent Counsel, Philips Electronics North America Corporation, 580 White Plains Road, Tarrytown, NY, 10591, US

(73) Assignee: KONINKLIJKE PHILIPS ELECTRONICS N.V.

(21) Appl. No.: 10/071,649

(22) Filed: Feb. 7, 2002

(51) Int. Cl. G06F 17/60

(52) U.S. Cl. 705/14; 705/1

(57) ABSTRACT

Alternative advertising is provided to substitute to an original advertisement that a user seeks to bypass in content. A user of an electronic device can request the device to skip the original advertisement. The skipping is enabled however an alternative advertisement representative of the original advertisement is presented to the user. The alternative advertisement is of a lower perceived intrusiveness than the original advertisement.

### FIELD OF THE INVENTION

The invention relates to direct advertising on the user's personal electronic devices. The invention is relevant to broadcast advertising of commercial segments between audio and/or video programs.

### BACKGROUND ART

Digital video recorders enable skipping commercials by fast forwarding through them when watching a previously recorded program. With new hard-disk drive based recorders it is possible to skip commercials in “live” television. Technically, this requires that the program that the individual is watching, is buffered via a video cache on the hard-disk drive and the program played-out is actually slightly time-shifted. Users have been given means to customize their TV experience and as a consequence, the service provider partially lost control over the viewer's experience. The user is now able to decide when and what to watch or skip.

Several image processing techniques exist to detect and automatically skip commercials in multimedia content when recording content.

International patent application WO 01/35409, herein incorporated by reference, proposes one possible way of detecting commercials in a television program. This document proposes a method and apparatus for controlling an MPEG video media recording device to automatically identify and selectively skip segments of a video signal, such as commercial advertisements, during a recording session. During an MPEG video data recording session the system continuously monitors the video data being recorded to detect a scene change, the system stores in a file a time and record location on the media corresponding to the occurrence of the scene change. Depending upon the time interval between several of the detected scene changes, the system identifies a corresponding video segment as either a commercial advertisement or a chapter boundary. By identifying the segments in this way, the playback presentation can then be selectively controlled.

These emerging and available technologies become a threat to the entertainment industry and especially to the television industry. The wide acceptance of personal television may mean a drop in the advertising revenues of most TV broadcasters since commercial advertisements may not have the same impact on the audience as they used to have with traditional broadcast television. An approach of the entertainment industry towards this threat was to find solutions to prevent subscribers from skipping commercial advertisements when watching time-shifted TV programs.

International application WO 99/37045, hereby incorporated by reference, proposes a digital radio broadcast system providing various interactive features including skip backward and skip forward. This document proposes tiers of service levels for nonpaying and paying subscribers. A scheme is given that allows access control. A paying subscriber can listen to commercial-free audio, while the non-paying consumer hears a combination of music and advertisements. The paying user is provided with access points to bypass the commercials. As to the non-paying user, the fast forward and skip features of his device are disabled so that he cannot bypass the commercial.

Reference is also made to US copending patent application Ser. No. 09/927,305, filed Aug. 10, 2001 for “Automatic commercial skipping service” incorporated herein by reference. This document provides a business model for enabling, upon payment of an extra fee, automatic skipping of the commercials without the need for the user to manually bypass the commercials.

### SUMMARY OF THE INVENTION

It is an object of the invention to overcome the conflict between the desire of consumers to skip commercial messages and the need of content distributors to offer effective and successful advertising channels.

It is another object of the invention to provide an advertisement scheme with minimal disturbance for the user while achieving efficient public awareness.

To this end, in an advertising method of the invention the device can detect a user's command for bypassing an original advertisement in content. The device is enabled to bypass the original advertisement however the device permits to present the user with an alternative advertisement. The alternative advertisement is representative of the original advertisement and is of a lower perceived intrusiveness than the original advertisement.

A method of the invention proposes an alternative solution to known multimedia advertising schemes in view of the user being capable of deciding what is presented to him. The invention relates to a type of advertising that directly and personally affects the user in his personal environment: in the office, at home or in his car. The inventor has realized that the advent of personal audio and video technologies gave the user a greater control power over his entertainment experience than to the content distributors. Indeed, the user can command the electronic device to bypass content segments. This can be done by configuring the device not to play out these segments when content is played out from a buffer in the device. This can also be done by configuring the device not to record them at the time full content is received and recorded by the electronic device. The invention substitutes the original advertisement with an alternative advertisement and thereby achieves a compromise between respective interests of content distributors and users. The user can still bypass the original advertisements but a less disturbing form of advertising is presented to him instead. The alternative advertisement can be a still picture or a clip shorter than a traditional television commercial break. The alternative advertisement can also be a logo or a graphic displayed for a period of time on a portion of content viewed by the user. The alternative advertisement is not necessarily presented to the user where content is played out. The alternative advertisement can be presented on an ancillary device, e.g. a remote control with display, a web tablet, a cell-phone or the like. In addition, an original video advertisement can be replaced with an alternative audio file played out on another device.

The invention permits content distributors to partially recover control over what the user watches or listens to and when. An advantage of one or more embodiments of the invention is to permit content distributors to sustain revenue from advertising through electronic devices while going in the direction of what the user wants, that is, having partial control over content.

The invention also relates to a device and a software application permitting alternative advertising according to the invention

### BRIEF DESCRIPTION OF THE DRAWING

The invention is explained in further details, by way of examples, and with reference to the accompanying drawing wherein:

FIG. 1 is a flowchart diagram of a method of the invention; and,

FIG. 2 is a block diagram of a device of the invention.

Elements within the drawing having similar or corresponding features are identified by like reference numerals.

### DETAILED DESCRIPTION

The invention is described in the context of multimedia advertising such as advertising on television, over the radio, cell-phones or any other electronic device. Advertising is usually done by inserting one or more commercial segments in entertainment programs transmitted to the electronic device of the user. The advertisement is either inserted in the program itself, thereby interrupting play out of the program or is part of a commercial break between two consecutive programs.

The electronic device enables skipping of portions of content upon user request. For example, a remote control associated with the electronic device comprises a “skip” button that triggers a command for bypassing a fixed portion of content, e.g. 30 seconds skipping or 60 seconds skipping. Portions of digital content may also be bypassed by increasing the play out speed. When increasing the play out speed, the device omits rendering portions of content and quickly jumps from one frame to another frame further in content.

In another embodiment, the electronic device may also enable skipping of portions when recording content in an internal memory for later retrieval. For example, the electronic device may offer various recording options such as record full content or record content without advertisements. When the second recording option is selected, the device detects the advertisement segments from received content. Various data processing techniques may be used for that purpose. For example, the device may carry scene changes detection algorithms or the device can look for flags, which indicate locations of advertisements in content. A content distributor or a third party may have previously inserted these flags or bookmarks before broadcast of content.

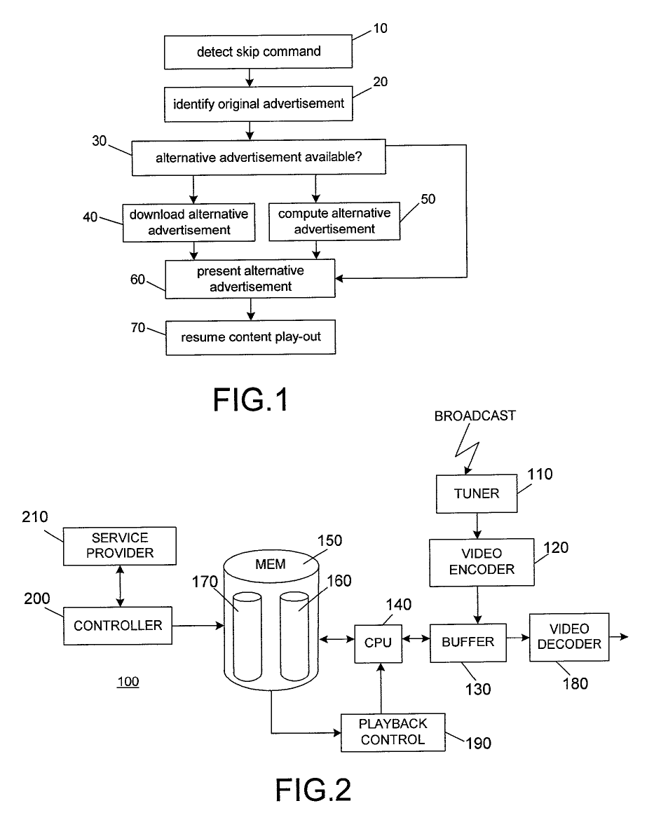

FIG. 1 is a flowchart diagram of an advertising method of the invention. First, in step 10, the electronic device of the invention detects a user-initiated command for bypassing an original advertisement present in content. The original advertisement may have been broadcast with content or the original advertisement may have been retrieved from a local advertisement repository and inserted in content prior to or at the time of transmission to the electronic device. In a first embodiment, the user sends the skip command while the device plays out content. The command configures the device to bypass the original advertisement in its entirety if the device recognizes bookmarks in content that indicate the beginning and end of the original advertisement in content. The command may also configure the device to skip 30 seconds of content irrespective of whether the original advertisement is shorter or longer than 30 seconds. The advertisement is in this case either fully or partially skipped. In a second embodiment, the user-initiated command is a command for recording commercial-free content. The user sends the command when he configures the device to record content or the command may be part of a setup of the device as the default recording mode of the device: “always record commercial-free content”.

Upon reception of the command, the device detects and identifies the original advertisement as shown in step 20. As mentioned previously, the original advertisement may be detected using video or audio data processing algorithms or using bookmarks. Metadata associated with the original advertisement may have been inserted in content to indicate, e.g. the product or service advertised, the advertiser identity, the channel broadcasting content and the program or content into which the advertisement is inserted. From such metadata, the device identifies the original advertisement that the user seeks to skip.

Once the original advertisement is identified, the device checks, in step 30, whether an alternative advertisement is locally present. In the invention, the alternative advertisement is of a lower perceived intrusiveness than the original advertisement. In the invention, “lower perceived intrusiveness” indicates that the alternative advertisement does not disturb the user as much as the original one. For example, the alternative advertisement may be a slogan scrolling in the lower portion of the screen or the alternative advertisement can be a still picture displayed for 2 seconds, which is less disturbing for the user than a traditional 30 seconds TV commercial. The alternative advertisement may also be a trademark or logo representing the brand or product advertised in the original advertisement. The logo may be displayed in transparence to content for a predetermined period of time, e.g. proportional to the duration of the original advertisement, when play out of content is resumed.

The alternative advertisement may be retrieved from an internal advertisement database or the alternative advertisement may have been received with content as will be explained hereinafter.

If the alternative advertisement is not locally present, it may be downloaded from an external repository in step 40 or internally computed in step 50. In an embodiment of the invention, the alternative advertisement is computed from the original advertisement.

Then, in step 60, the device enables presenting the alternative advertisement to the user. The alternative advertisement is either rendered on the same device as the one rendering content or the alternative advertisement is rendered on a separate device such as a remote control. In step 70 of a method of the invention, play out of content is resumed with the original advertisement being partly skipped. The original advertisement is not necessarily fully skipped. The original advertisement is only partly skipped if, for example, the user had watched part of it before requesting the device to skip it or if the command triggers a 30 second skip and the original advertisement is longer than 30 seconds.

The order of implementation of the steps shown in FIG. 1 is only given as an example. Indeed, the original advertisement may be skipped and play out of, or before the alternative advertisement is even retrieved or computed. In addition, the alternative advertisement may be rendered to the user later in time after play out of content is resumed.

The device may also identify within received content all commercial segments in content before playing out content so that in the event a skip command is received to bypass a specific one of the commercial segments, the device can automatically substitute the original advertisement with an alternative one.

FIG. 2 shows a block diagram of an embodiment of a device 200 of the invention. The device 200 is a personal video recorder and the embodiment is here given in the context of television advertising. However the invention is not limited to television advertising and other advertising models are also within the scope of the invention. For example, the invention also relates to audio advertising on air-broadcast radio, audio advertising on internet-streamed radio, or audio/video advertising via messages or files delivered to cell-phones, PDAs, Web tablets or the like.

A tuner 110 receives broadcast content from a content distributor and transmits content to a video encoder 120. The video encoder 120 encodes received content in a format adapted for storage in the memory unit 150, e.g. MPEG-2. The encoder 120 provides encoded content to a buffer 130, and a central processing unit 140 controls the transfer of encoded content from the buffer 130 to the memory unit 150. The central processing unit 140 also controls the transfer of content from memory 150 to the buffer 130 and further to a decoder 180 when content is played out. A playback control unit 190 controls the playback of content in response to requests from the user or previous settings. For example, the playback control 190 monitors the CPU 140 to skip one or more commercial advertisement in content upon user's request.

The memory 150 comprises a first memory arrangement 170 for storing received content and a second memory arrangement 160 for storing alternative advertisements of the invention. Content is received with the original advertisements. Content may be stored in memory 170 with or without the original advertisements based on a setup of the device 100. The device 100 may enable a commercial-free recording mode. In this mode, the original advertisements are automatically removed from broadcast content and advertisement-free content is stored in the memory 170. A controller 200 identifies the original advertisements removed from received content and requests the alternative advertisements from service provider 210. Such request may be done through a daily or weekly dial-up call to the service provider 210 for all recorded contents stored in the memory 170. The alternative advertisements, e.g. a set of still logos or pictures associated with a respective one of the original advertisements, may be transmitted to the device 100 along with, e.g. the electronic program guide.

Content and the original advertisements may also be stored in the memory 170 or in the buffer 130 when the user is watching “live” television with a few minutes delay. The playback control 190 enables skipping through the original advertisement upon request of the user and controls the CPU 140 to retrieve the alternative advertisement for display on the same device as the one playing out content or on a different one, e.g. Web-pad or remote control. The alternative advertisement can also be displayed at a later time.

In another embodiment, broadcast content comprises both the original and alternative advertisements. For example, steganography techniques may be used. Steganography is the technique whereby a message, possibly encrypted, is concealed within another medium. In the world of computing, this means that a seemingly innocuous graphic or sound file (say) can conceal a hidden message being text or an image. For example, a URL or a unique identifier of an alternative advertisement can be embedded into an MPEG-2 stream as a watermark. In another embodiment, the URL is broadcast in vertical blanking interval (VBI) of the television data stream. The URL is extracted and then used to retrieve the alternative advertisement from a remote repository. A look-up table of such URLs may be created to facilitate access to alternative advertisements when requested by the system. The URL may be communicated to a handheld device, e.g. web pad, cell phone, remote control or the like. The handheld device may present the alternative advertisement in a non-obtrusive way, e.g. as a screen saver.

In yet another embodiment of the invention, the alternative advertisement is internally computed from the original advertisement. Image processing techniques may be used to detect a logo or trademark representative of the brand or the advertised product or to detect a main sequence in the original advertisement. The controller 200 may generate the alternative advertisement therefrom. For example, a televised advertisement often comprises a conclusive still or animated sequence clearly showing the advertised brand or product to reinforce the message that the advertiser seeks to transmit. The alternative advertisement may comprise or even consist in this conclusive sequence of the original advertisement.

In yet another embodiment of the invention, the device provides information to the service provider or a third party, e.g. a content provider or an advertisement agency, representative of actual advertisements skipped or viewed by the user. The information may be used to determine compensation or payments associated with content presented to the user.

1. A method of advertising via an electronic device of a user, the method comprising:
enabling the device to detect a user's command for bypassing through an original advertisement in content;
enabling the device to bypass through the original advertisement; and,
enabling to render to the user an alternative advertisement representative of the original advertisement and of a lower perceived intrusiveness than the original advertisement.

2. The method of claim 1, wherein the user's command configures the device to record content without the original advertisement; and, the method further comprising:
enabling to insert the alternative advertisement in recorded content.

3. The method of claim 1, wherein the user's command configures the device to bypass through the original advertisement when playing out content recorded in the device with the original advertisement; and, wherein the alternative advertisement is rendered in lieu of the original advertisement.

4. The method of claim 1, further comprising:
preventing the user from bypassing through the alternative advertisement.

5. The method of claim 1, wherein the alternative advertisement is a video and audio clip of a shorter duration than that of the original advertisement.

6. The method of claim 1, wherein the alternative advertisement is a still picture.

7. The method of claim 1, wherein the alternative advertisement is rendered on a display of a remote control device associated with the electronic device.

8. The method of claim 1, wherein the alternative advertisement is a graphic displayed on transparence to content when content is played out to the user.

9. An electronic device enabling advertising, the device comprising:
a storage medium storing content including an original advertisement, and an alternative advertisement representative of the original advertisement and of lower perceived intrusiveness than the original advertisement;
a controller controlling a recording and a rendering of content to the user in response to commands from the user, the controller being operative to control a rendering of the alternative advertisement when a user's command for bypassing through the original advertisement is detected.

10. The device of claim 9, wherein the device is configured, in response to the user's command, to record content without the original advertisement and the controller is further configured to insert the alternative advertisement in recorded content.

11. The device of claim 9, wherein the controller is configured, in response to the user's command, to bypass through the original advertisement when playing out content; and, wherein the controller replaces the original advertisement with the alternative advertisement when playing content.

12. The device of claim 9, wherein the controller prevents the user from bypassing through the alternative advertisement.

13. The device of claim 9, wherein the alternative advertisement is a video and audio clip of a shorter duration than that of the original advertisement.

14. The device of claim 9, wherein the alternative advertisement is a still picture.

15. The device of claim 9, wherein the alternative advertisement is rendered on a display of a remote control device associated with the electronic device.

16. A device of claim 9, wherein the alternative advertisement is a graphic displayed on transparence to content when content is played out to the user.

17. A software application for enabling advertising on an electronic device of a user, the software application comprising instructions for enabling the device to carry out the following steps:
detecting a user's command for bypassing through an original advertisement in content;
bypassing through the original advertisement; and,
rendering to the user an alternative advertisement representative of the original advertisement and of a lower perceived intrusiveness than the original advertisement.
